(19) United States
(12) Patent Application Publication
(10) Pub. No.: US 2020/0106514 A1
(43) Pub. Date: Apr. 2, 2020

(54) Wireless Repeater with Integrated Detachable Antenna

(71) Applicant: WILSON ELECTRONICS, LLC, St. George, UT (US)

(72) Inventor: Christopher Ken Ashworth, Toquerville, UT (US)

(21) Appl. No.: 16/586,741

(22) Filed: Sep. 27, 2019

Related U.S. Application Data
(60) Provisional application No. 62/737,766, filed on Sep. 27, 2018.

(51) Int. Cl. H04B 7/14; H01Q 1/42; H01Q 15/14

(52) U.S. Cl. CPC H04B 7/14; H01Q 15/14; H01Q 1/42

(57) ABSTRACT

A wireless repeater system, in accordance with embodiments, can include a first enclosure and a second enclosure. A repeater can be disposed in the first enclosure, and a donor antenna can be disposed in the second enclosure. The second enclosure can be selectively configurable to be coupled with the first enclosure as a unitary structure, or as a separate structure from the first enclosure. A reflector can be coupled to the second enclosure, be disposed in the second enclosure, be integral to the second enclosure, or be removably disposed between the first enclosure and the second enclosure when the second enclosure is coupled to the first enclosure as a unitary structure.

### RELATED APPLICATIONS

The present application claims the benefit of U.S. Provisional Patent Application No. 62/737,766 filed Sep. 27, 2018 with a docket number of 3969-141.PROV, the entire specification of which is hereby incorporated by reference in its entirety for all purposes.

### BACKGROUND

Signal boosters and repeaters can be used to increase the quality of wireless communication between a wireless device and a wireless communication access point, such as a cell tower. Repeaters can enhance the quality of the wireless communication by amplifying, filtering, and/or applying other processing techniques to uplink and downlink signals communicated between the wireless device and the wireless communication access point.

As an example, the repeater can receive, via an antenna, downlink signals from the wireless communication access point. The repeater can amplify the downlink signal and then provide an amplified downlink signal to the wireless device. In other words, the repeater can act as a relay between the wireless device and the wireless communication access point. As a result, the wireless device can receive a stronger signal from the wireless communication access point. Similarly, uplink signals from the wireless device (e.g., telephone calls and other data) can be directed to the repeater. The repeater can amplify the uplink signals before communicating, via an antenna, the uplink signals to the wireless communication access point.

### DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 depicts a wireless repeater system, in accordance with an example;

FIG. 2 depicts a wireless repeater system, in accordance with an example;

FIG. 3 depicts a wireless repeater system, in accordance with an example;

FIGS. 4A-4D depict a wireless repeater system, in accordance with an example;

FIGS. 5A-5D depict a wireless repeater system, in accordance with an example;

FIGS. 6A-6D depict a wireless repeater system, in accordance with an example;

FIG. 7 illustrates deployment of a wireless repeater system, in accordance with an example;

FIGS. 8A and 8B depict a wireless repeater system, in accordance with an example; and

FIGS. 9A and 9B depict a wireless repeater system, in accordance with another example.

Reference will now be made to the exemplary embodiments illustrated, and specific language will be used herein to describe the same. It will nevertheless be understood that no limitation of the scope of the technology is thereby intended.

### DETAILED DESCRIPTION OF THE INVENTION

Before the present technology is disclosed and described, it is to be understood that this technology is not limited to the particular structures, process actions, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating actions and operations and do not necessarily indicate a particular order or sequence.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

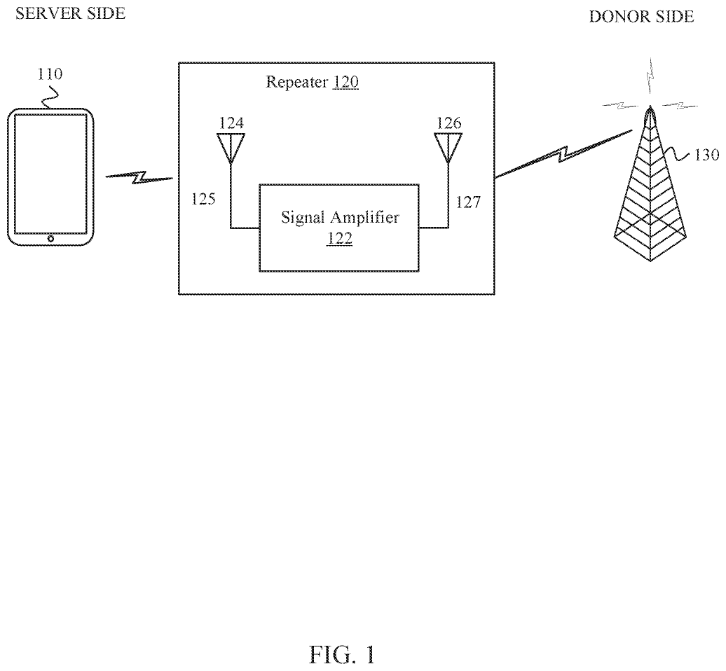

Wireless communication systems, such as cellular telephone systems, have become common throughout the world. A signal booster 120 (or wireless repeater) is a radio frequency (RF) device used to amplify wireless communication signals in both uplink and downlink communication channels, as illustrated in FIG. 1. The uplink channel is generally referred to as the direction from a wireless device 110 to a base station 130. The downlink channel is generally referred to as the direction from the base station 130 to the wireless device 110. For a wireless telephone system, the base station 130 may be a cell tower, and the wireless device 110 may be one or more smart phones, one or more tablets, one or more laptops, one or more desktop computers, one or more multimedia devices such as a televisions and gaming systems, one or more cellular internet of things (CIoT) devices, or other types of computing devices. The repeater 120 typically includes one or more signal amplifier, one or more duplexers and/or couplers, one or more filters and other circuits coupled between two or more antennas. The antennas can include one or more server antennas 124 and one or more donor antennas 126.

In one configuration, the repeater 120 can be an electronic device used to amplify (or boost) signals. The repeater 120 (also referred to as a cellular signal amplifier) can enhance the quality of wireless communication by amplifying, filtering, and/or applying other processing techniques via a signal amplifier 122 to uplink signals communicated from the wireless device 110 to the base station 130 and/or downlink signals communicated from the base station 130 to the wireless device 110. In other words, the repeater 120 can amplify or boost uplink signals and/or downlink signals bi-directionally. In one example, the repeater 120 can be at a fixed location, such as in a home or office. Alternatively, the repeater 120 can be attached to a mobile object, such as a vehicle or a wireless device 110.

In one configuration, the repeater 120 can include the server antenna 124 (e.g., an integrated device antenna or inside antenna or coupling antenna) and the donor antenna 126 (e.g., an integrated node antenna or outside antenna). The integrated node antenna 126 can receive the downlink signal from the base station 130. The downlink signal can be provided to the signal amplifier 122 via a second coaxial cable 127 or other type of radio frequency connection operable to communicate radio frequency signals. The signal amplifier 122 can include one or more cellular signal amplifiers for amplification and filtering. The downlink signal that has been amplified and filtered can be provided to the server antenna 124 via a first coaxial cable 125 or other type of radio frequency connection operable to communicate radio frequency signals. The server antenna 124 can wirelessly communicate the downlink signal that has been amplified and filtered to the wireless device 110.

Similarly, the server antenna 124 can receive an uplink signal from the wireless device 110. The uplink signal can be provided to the signal amplifier 122 via the first coaxial cable 125 or other type of radio frequency connection operable to communicate radio frequency signals. The signal amplifier 122 can include one or more cellular signal amplifiers for amplification and filtering. The uplink signal that has been amplified and filtered can be provided to the donor antenna 126 via the second coaxial cable 127 or other type of radio frequency connection operable to communicate radio frequency signals. The donor antenna 126 can communicate the uplink signal that has been amplified and filtered to the base station 130.

In one example, the repeater 120 can filter the uplink and downlink signals using any suitable analog or digital filtering technology including, but not limited to, surface acoustic wave (SAW) filters, bulk acoustic wave (BAW) filters, film bulk acoustic resonator (FBAR) filters, ceramic filters, waveguide filters or low-temperature co-fired ceramic (LTCC) filters.

In one example, the repeater 120 can send uplink signals to a node and/or receive downlink signals from the node. The node can comprise a wireless wide area network (WWAN) access point (AP), a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or another type of WWAN access point.

In one configuration, the repeater 120 used to amplify the uplink and/or a downlink signal is a handheld booster. The handheld booster can be implemented in a sleeve of the wireless device 110. The wireless device sleeve can be attached to the wireless device 110, but can be removed as needed. In this configuration, the repeater 120 can automatically power down or cease amplification when the wireless device 110 approaches a particular base station. In other words, the repeater 120 can determine to stop performing signal amplification when the quality of uplink and/or downlink signals is above a defined threshold based on a location of the wireless device 110 in relation to the base station 130.

In one example, the repeater 120 can include a battery to provide power to various components, such as the signal amplifier 122, the server antenna 124 and the donor antenna 126. The battery can also power the wireless device 110 (e.g., phone or tablet). Alternatively, the repeater 120 can receive power from the wireless device 110.

In one configuration, the repeater 120 can be a Federal Communications Commission (FCC)-compatible consumer signal booster. As a non-limiting example, the repeater 120 can be compatible with FCC Part 20 or 47 Code of Federal Regulations (C.F.R.) Part 20.21 (Mar. 21, 2013). In addition, the repeater 120 can operate on the frequencies used for the provision of subscriber-based services under parts 22 (Cellular), 24 (Broadband PCS), 27 (AWS-1, 700 MHz Lower A-E Blocks, and 700 MHz Upper C Block), and 90 (Specialized Mobile Radio) of 47 C.F.R. The repeater 120 can be configured to automatically self-monitor its operation to ensure compliance with applicable noise and gain limits. The repeater 120 can either self-correct or shut down automatically if the repeater's operations violate the regulations defined in FCC Part 20.21.

In one configuration, the repeater 120 can enhance the wireless connection between the wireless device 110 and the base station 130 (e.g., cell tower) or another type of wireless wide area network (WWAN) access point (AP) by amplifying desired signals relative to a noise floor. The repeater 120 can boost signals for cellular standards, such as the Third Generation Partnership Project (3GPP) Long Term Evolution (LTE) Release 8, 9, 10, 11, 12, 13, 14, 15, or 16 standards or Institute of Electronics and Electrical Engineers (IEEE) 802.16. In one configuration, the repeater 120 can boost signals for 3GPP LTE Release 16.2.0 (July 2019) or other desired releases.

The repeater 120 can boost signals from the 3GPP Technical Specification (TS) 36.101 (Release 16 Jul. 2019) bands or LTE frequency bands. For example, the repeater 120 can boost signals from the LTE frequency bands: 2, 4, 5, 12, 13, 17, 25, and 26. In addition, the repeater 120 can boost selected frequency bands based on the country or region in which the repeater is used, including any of bands 1-85 or other bands, as disclosed in 3GPP TS 36.104 V16.2.0 (July 2019), and depicted in Table 1:

TABLE 1

| | | Downlink (DL) operating | |
|---|---|---|---|
| | Uplink (UL) operating band | band | |
| LTE | BS receive | BS transmit | |
| Operating | UE transmit | UE receive | Duplex |
| Band | F_{UL}_{_{—}}_{low}-F_{UL}_{_{—}}_{high} | F_{DL}_{_{—}}_{low}-F_{DL}_{_{—}}_{high} | Mode |
| 1 | 1920 MHz-1980 MHz | 2110 MHz-2170 MHz | FDD |
| 2 | 1850 MHz-1910 MHz | 1930 MHz-1990 MHz | FDD |
| 3 | 1710 MHz-1785 MHz | 1805 MHz-1880 MHz | FDD |
| 4 | 1710 MHz-1755 MHz | 2110 MHz-2155 MHz | FDD |
| 5 | 824 MHz-849 MHz | 869 MHz-894 MHz | FDD |
| 6 (NOTE 1) | 830 MHz-840 MHz | 875 MHz-885 MHz | FDD |
| 7 | 2500 MHz-2570 MHz | 2620 MHz-2690 MHz | FDD |
| 8 | 880 MHz-915 MHz | 925 MHz-960 MHz | FDD |
| 9 | 1749.9 MHz-1784.9 MHz | 1844.9 MHz-1879.9 MHz | FDD |
| 10 | 1710 MHz-1770 MHz | 2110 MHz-2170 MHz | FDD |
| 11 | 1427.9 MHz-1447.9 MHz | 1475.9 MHz-1495.9 MHz | FDD |
| 12 | 699 MHz-716 MHz | 729 MHz-746 MHz | FDD |
| 13 | 777 MHz-787 MHz | 746 MHz-756 MHz | FDD |
| 14 | 788 MHz-798 MHz | 758 MHz-768 MHz | FDD |
| 15 | Reserved | Reserved | FDD |
| 16 | Reserved | Reserved | FDD |
| 17 | 704 MHz-716 MHz | 734 MHz-746 MHz | FDD |
| 18 | 815 MHz-830 MHz | 860 MHz-875 MHz | FDD |
| 19 | 830 MHz-845 MHz | 875 MHz-890 MHz | FDD |
| 20 | 832 MHz-862 MHz | 791 MHz-821 MHz | FDD |
| 21 | 1447.9 MHz-1462.9 MHz | 1495.9 MHz-1510.9 MHz | FDD |
| 22 | 3410 MHz-3490 MHz | 3510 MHz-3590 MHz | FDD |
| 23¹ | 2000 MHz-2020 MHz | 2180 MHz-2200 MHz | FDD |
| 24 | 1626.5 MHz-1660.5 MHz | 1525 MHz-1559 MHz | FDD |
| 25 | 1850 MHz-1915 MHz | 1930 MHz-1995 MHz | FDD |
| 26 | 814 MHz-849 MHz | 859 MHz-894 MHz | FDD |
| 27 | 807 MHz-824 MHz | 852 MHz-869 MHz | FDD |
| 28 | 703 MHz-748 MHz | 758 MHz-803 MHz | FDD |
| 29 | N/A | 717 MHz-728 MHz | FDD (NOTE 2) |
| 30 | 2305 MHz-2315 MHz | 2350 MHz-2360 MHz | FDD |
| 31 | 452.5 MHz-457.5 MHz | 462.5 MHz-467.5 MHz | FDD |
| 32 | N/A | 1452 MHz-1496 MHz | FDD (NOTE 2) |
| 33 | 1900 MHz-1920 MHz | 1900 MHz-1920 MHz | TDD |
| 34 | 2010 MHz-2025 MHz | 2010 MHz-2025 MHz | TDD |
| 35 | 1850 MHz-1910 MHz | 1850 MHz-1910 MHz | TDD |
| 36 | 1930 MHz-1990 MHz | 1930 MHz-1990 MHz | TDD |
| 37 | 1910 MHz-1930 MHz | 1910 MHz-1930 MHz | TDD |
| 38 | 2570 MHz-2620 MHz | 2570 MHz-2620 MHz | TDD |
| 39 | 1880 MHz-1920 MHz | 1880 MHz-1920 MHz | TDD |
| 40 | 2300 MHz-2400 MHz | 2300 MHz-2400 MHz | TDD |
| 41 | 2496 MHz-2690 MHz | 2496 MHz-2690 MHz | TDD |
| 42 | 3400 MHz-3600 MHz | 3400 MHz-3600 MHz | TDD |
| 43 | 3600 MHz-3800 MHz | 3600 MHz-3800 MHz | TDD |
| 44 | 703 MHz-803 MHz | 703 MHz-803 MHz | TDD |
| 45 | 1447 MHz-1467 MHz | 1447 MHz-1467 MHz | TDD |
| 46 | 5150 MHz-5925 MHz | 5150 MHz-5925 MHz | TDD (NOTE 3, |
| | | | NOTE 4) |
| 47 | 5855 MHz-5925 MHz | 5855 MHz-5925 MHz | TDD |
| 48 | 3550 MHz-3700 MHz | 3550 MHz-3700 MHz | TDD |
| 49 | 3550 MHz-3700 MHz | 3550 MHz-3700 MHz | TDD (NOTE 8) |
| 50 | 1432 MHz-1517 MHz | 1432 MHz-1517 MHz | TDD |
| 51 | 1427 MHz-1432 MHz | 1427 MHz-1432 MHz | TDD |
| 52 | 3300 MHz-3400 MHz | 3300 MHz-3400 MHz | TDD |
| 53 | 2483.5 MHz-2495 MHz | 2483.5 MHz-2495 MHz | TDD |
| 65 | 1920 MHz-2010 MHz | 2110 MHz-2200 MHz | FDD |
| 66 | 1710 MHz-1780 MHz | 2110 MHz-2200 MHz | FDD (NOTE 5) |
| 67 | N/A | 738 MHz-758 MHz | FDD (NOTE 2) |
| 68 | 698 MHz-728 MHz | 753 MHz-783 MHz | FDD |
| 69 | N/A | 2570 MHz-2620 MHz | FDD (NOTE 2) |
| 70 | 1695 MHz-1710 MHz | 1995 MHz-2020 MHz | FDD⁶ |
| 71 | 663 MHz-698 MHz | 617 MHz-652 MHz | FDD |
| 72 | 451 MHz-456 MHz | 461 MHz-466 MHz | FDD |
| 73 | 450 MHz-455 MHz | 460 MHz-465 MHz | FDD |
| 74 | 1427 MHz-1470 MHz | 1475 MHz-1518 MHz | FDD |
| 75 | N/A | 1432 MHz-1517 MHz | FDD (NOTE 2) |
| 76 | N/A | 1427 MHz-1432 MHz | FDD (NOTE 2) |
| 85 | 698 MHz-716 MHz | 728 MHz-746 MHz | FDD |
| 87 | 410 MHz-415 MHz | 420 MHz-425 MHz | FDD |
| 88 | 412 MHz-417 MHz | 422 MHz-427 MHz | FDD |

(NOTE 1) Band 6, 23 are not applicable.
(NOTE 2) Restricted to E-UTRA operation when carrier aggregation is configured. The downlink operating band is paired with the uplink operating band (external) of the carrier aggregation configuration that is supporting the configured Pcell.
(NOTE 3) This band is an unlicensed band restricted to licensed-assisted operation using Frame Structure Type 3.
(NOTE 4) Band 46 is divided into four sub-bands as in Table 5.5-1A.
(NOTE 5) The range 2180-2200 MHz of the DL operating band is restricted to E-UTRA operation when carrier aggregation is configured.
(NOTE 6) The range 2010-2020 MHz of the DL operating band is restricted to E-UTRA operation when carrier aggregation is configured and TX-RX separation is 300 MHz. The range 2005-2020 MHz of the DL operating band is restricted to E-UTRA operation when carrier aggregation is configured and TX-RX separation is 295 MHz.
(NOTE 7) Void
(NOTE 8) This band is restricted to licensed-assisted operation using Frame Structure Type 3.

In another configuration, the repeater 120 can boost signals from the 3GPP Technical Specification (TS) 38.104 (Release 16 Jul. 2019) bands or 5G frequency bands. In addition, the repeater 120 can boost selected frequency bands based on the country or region in which the repeater is used, including any of bands n1-n86 in frequency range 1 (FR1), n257-n261 in frequency range 2 (FR2), or other bands, as disclosed in 3GPP TS 38.104 V16.0.0 (July 2019), and depicted in Table 2 and Table 3:

TABLE 2

| | Uplink (UL) | Downlink (DL) | |
|---|---|---|---|
| | operating band | operating band | |
| NR | BS receive/ | BS transmit/ | |
| operating | UE transmit | UE receive | Duplex |
| band | F_{UL,low}-F_{UL,high} | F_{DL,low}-F_{DL,high} | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n12 | 699 MHz-716 MHz | 729 MHz-746 MHz | FDD |
| n14 | 788 MHz-798 MHz | 758 MHz-768 MHz | FDD |
| n18 | 815 MHz-830 MHz | 860 MHz-875 MHz | FDD |
| n20 | 832 MHz-862 MHz | 791 MHz-821 MHz | FDD |
| n25 | 1850 MHz-1915 MHz | 1930 MHz-1995 MHz | FDD |
| n28 | 703 MHz-748 MHz | 758 MHz-803 MHz | FDD |
| n30 | 2305 MHz-2315 MHz | 2350 MHz-2360 MHz | FDD |
| n34 | 2010 MHz-2025 MHz | 2010 MHz-2025 MHz | TDD |
| n38 | 2570 MHz-2620 MHz | 2570 MHz-2620 MHz | TDD |
| n39 | 1880 MHz-1920 MHz | 1880 MHz-1920 MHz | TDD |
| n40 | 2300 MHz-2400 MHz | 2300 MHz-2400 MHz | TDD |
| n41 | 2496 MHz-2690 MHz | 2496 MHz-2690 MHz | TDD |
| n48 | 3550 MHz-3700 MHz | 3550 MHz-3700 MHz | TDD |
| n50 | 1432 MHz-1517 MHz | 1432 MHz-1517 MHz | TDD |
| n51 | 1427 MHz-1432 MHz | 1427 MHz-1432 MHz | TDD |
| n65 | 1920 MHz-2010 MHz | 2110 MHz-2200 MHz | FDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |
| n86 | 1710 MHz-1780 MHz | N/A | SUL |
| [n90] | 2496 MHz-2690 MHz | 2496 MHz-2690 MHz | TDD |

TABLE 3

| | Uplink (UL) and Downlink (DL) | |
|---|---|---|
| | operating band | |
| | BS transmit/receive | |
| NR | UE transmit/receive | |
| operating | F_{UL,low}-F_{UL,high} | Duplex |
| band | F_{DL,low}-F_{DL,high} | Mode |
| n257 | 26500 MHz-29500 MHz | TDD |
| n258 | 24250 MHz-27500 MHz | TDD |
| n260 | 37000 MHz-40000 MHz | TDD |
| n261 | 27500 MHz-28350 MHz | TDD |

The number of LTE or 5G frequency bands and the level of signal enhancement can vary based on a particular wireless device, cellular node, or location. Additional domestic and international frequencies can also be included to offer increased functionality. Selected models of the repeater 120 can be configured to operate with selected frequency bands based on the location of use. In another example, the repeater 120 can automatically sense from the wireless device 110 or base station 130 (or GPS, etc.) which frequencies are used, which can be a benefit for international travelers.

In one example, the server antenna 124 and the donor antenna 126 can be comprised of a single antenna, an antenna array, or have a telescoping form-factor. In another example, the server antenna 124 and the donor antenna 126 can be a microchip antenna. An example of a microchip antenna is AMMAL001. In yet another example, the server antenna 124 and the donor antenna 126 can be a printed circuit board (PCB) antenna. An example of a PCB antenna is TE 2118310-1.

In one example, the server antenna 124 can receive uplink (UL) signals from the wireless device 100 and transmit DL signals to the wireless device 100 using a single antenna. Alternatively, the server antenna 124 can receive UL signals from the wireless device 100 using a dedicated UL antenna, and the server antenna 124 can transmit DL signals to the wireless device 100 using a dedicated DL antenna.

In one example, the server antenna 124 can communicate with the wireless device 110 using near field communication. Alternatively, the server antenna 124 can communicate with the wireless device 110 using far field communication.

In one example, the donor antenna 126 can receive downlink (DL) signals from the base station 130 and transmit uplink (UL) signals to the base station 130 via a single antenna. Alternatively, the donor antenna 126 can receive DL signals from the base station 130 using a dedicated DL antenna, and the donor antenna 126 can transmit UL signals to the base station 130 using a dedicated UL antenna.

In one configuration, multiple repeaters can be used to amplify UL and DL signals. For example, a first repeater can be used to amplify UL signals and a second repeater can be used to amplify DL signals. In addition, different repeaters can be used to amplify different frequency ranges.

In one configuration, the repeater 120 can be configured to identify when the wireless device 110 receives a relatively strong downlink signal. An example of a strong downlink signal can be a downlink signal with a signal strength greater than approximately −80 dBm. The repeater 120 can be configured to automatically turn off selected features, such as amplification, to conserve battery life. When the repeater 120 senses that the wireless device 110 is receiving a relatively weak downlink signal, the integrated booster can be configured to provide amplification of the downlink signal. An example of a weak downlink signal can be a downlink signal with a signal strength less than −80 dBm.

In one example, the repeater 120 can also include one or more of: a waterproof casing, a shock absorbent casing, a flip-cover, a wallet, or extra memory storage for the wireless device. In one example, extra memory storage can be achieved with a direct connection between the repeater 120 and the wireless device 110. In another example, Near-Field Communications (NFC), Bluetooth v4.0, Bluetooth Low Energy, Bluetooth v4.1, Bluetooth v4.2, Bluetooth v5, Bluetooth v5.1, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, IEEE 802.11ad, or IEEE 802.11ax can be used to couple the repeater 120 with the wireless device 110 to enable data from the wireless device 110 to be communicated to and stored in the extra memory storage that is integrated in the repeater 120. Alternatively, a connector can be used to connect the wireless device 110 to the extra memory storage.

In one example, the repeater 120 can include photovoltaic cells or solar panels as a technique of charging the integrated battery and/or a battery of the wireless device 110. In another example, the repeater 120 can be configured to communicate directly with other wireless devices with repeaters. In one example, the donor antenna 126 can communicate over Very High Frequency (VHF) communications directly with integrated node antennas of other repeaters. The repeater 120 can be configured to communicate with the wireless device 110 through a direct connection, Near-Field Communications (NFC), Bluetooth v4.0, Bluetooth Low Energy, Bluetooth v4.1, Bluetooth v4.2, Bluetooth v5.0, Bluetooth v5.1, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, IEEE 802.11ad, IEEE 802.11ax, a TV White Space Band (TVWS), or any other industrial, scientific and medical (ISM) radio band. Examples of such ISM bands include 2.4 GHz, 3.6 GHz, 4.9 GHz, 5 GHz, or 5.9 GHz. This configuration can allow data to pass at high rates between multiple wireless devices with repeaters. This configuration can also allow users to send text messages, initiate phone calls, and engage in video communications between wireless devices with repeaters. In one example, the donor antenna 126 can be configured to couple to the wireless device 110. In other words, communications between the donor antenna 126 and the wireless device 110 can bypass the integrated booster.

In another example, a separate VHF node antenna can be configured to communicate over VHF communications directly with separate VHF node antennas of other repeaters. This configuration can allow the donor antenna 126 to be used for simultaneous cellular communications. The separate VHF node antenna can be configured to communicate with the wireless device 110 through a direct connection, Near-Field Communications (NFC), Bluetooth v4.0, Bluetooth Low Energy, Bluetooth v4.1, Bluetooth v4.2, Bluetooth v5.0, Bluetooth v5.1, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, IEEE 802.11ad, IEEE 802.11ax, a TV White Space Band (TVWS), or any other industrial, scientific and medical (ISM) radio band.

In one configuration, the repeater 120 can be configured for satellite communication. In one example, the donor antenna 126 can be configured to act as a satellite communication antenna. In another example, a separate node antenna can be used for satellite communications. The repeater 120 can extend the range of coverage of the wireless device 110 configured for satellite communication. The donor antenna 126 can receive downlink signals from satellite communications for the wireless device 110. The repeater 120 can filter and amplify the downlink signals from the satellite communication. In another example, during satellite communications, the wireless device 110 can be configured to couple to the repeater 120 via a direct connection or an ISM radio band. Examples of such ISM bands include 2.4 GHz, 3.6 GHz, 4.9 GHz, 5 GHz, or 5.9 GHz.

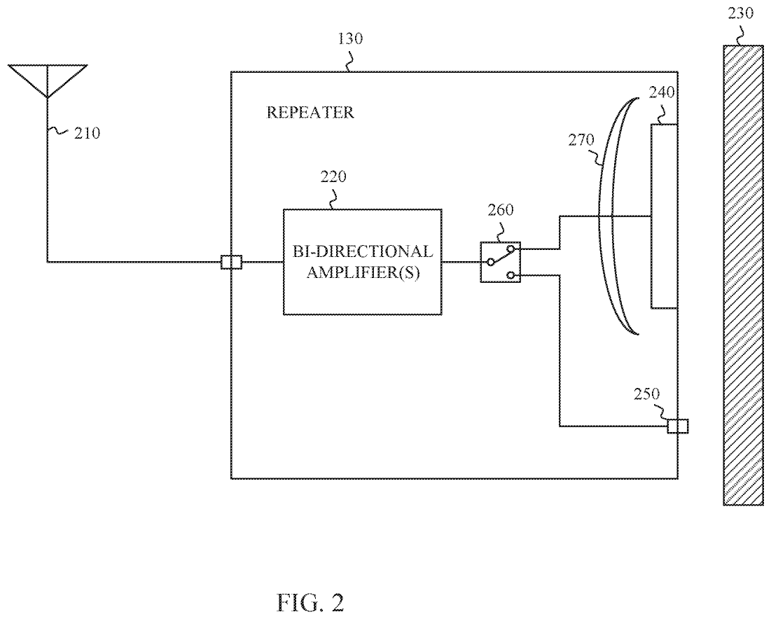

FIG. 2 depicts a wireless repeater system, in accordance with an example. The repeater can be designed for use within a structure such as a house, condominium, apartment, office building or the like. A server antenna 210 can be coupled to one or more bi-directional amplifiers 220 of the repeater 130. The repeater 130 and the server antenna 210 can be placed within the structure 230 for transmitting and receiving communications signal between the repeater 130 and one or more user equipment devices. The one or more bi-directional amplifiers 220 can amplify server-side communication signals transmitted to the user equipment devices and/or amplify the communication signals received from the user equipment devices. The repeater 130 can include an integrated donor antenna 240 coupled to the one or more bi-directional amplifiers 220. The integrated donor antenna 240 can amplify the donor-side communication signals transmitted to a based station and/or received from the base station.

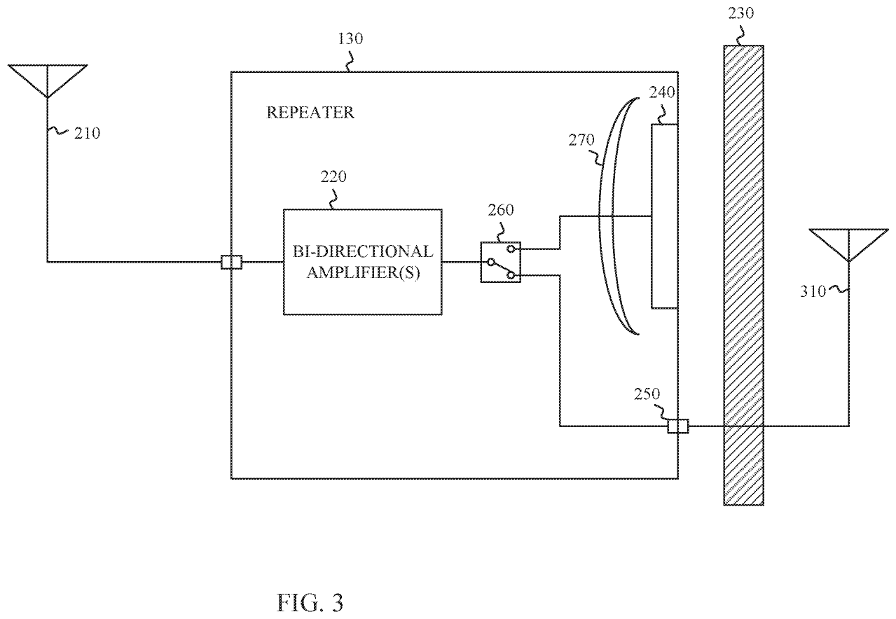

In some instances, the donor side communication signals received by the one or more bi-direction amplifiers 220 may be too weak inside the structure 230 due to losses caused by windows, doors, walls and the like, of the structure 230. Therefore, as illustrated in FIG. 3, the repeater 130 can also include an external donor antenna port 250 and a switch 260 to select either the integrated donor antenna 240 or an external donor antenna 310. The external donor antenna 310 can be placed outside the structure 230 where the donor-side communication signals will likely be stronger. A reflector 270 can also be utilized to increase the gain of transmitted and/or received communication signals. The reflector 270 can also be utilized with the integrated donor antenna 240 and/or the external donor antenna 310 to reduce cross coupling between the integrated or external donor antenna 240, 310 and the server antenna 210.

The inclusion of an integrated donor antenna 240, an external donor antenna 310, the external donor antenna port 250, and the switch 260 increases the complexity and cost of the repeater 130. Therefore, there is a continuing desire for enhanced repeaters for use within structures.

In aspects, a wireless repeater system can include a first form factor and a second form factor. The first form factor can house a repeater, and the second form factor can include a donor antenna. The first and second form factors can be integrally coupled together, or separated from each other. For example, when wireless signals between a base station and the wireless repeater system are above a desired level, the first and second form factors can be placed as a unitary structure in a first location inside a house, condominium, apartment, office building, or the like. However, when the wireless signals between the base station and the wireless repeater system are below a desired level, the first form factor housing the repeater can be placed inside, and the second form factor housing the donor antenna can be placed outside. The first form factor can be placed in a location convenient for plugging the repeater into an electrical outlet, which is also near a door, window or other passage through the walls of the structure that is convenient for routing an RF connection coupling the repeater in the first form factor to the donor antenna in the second form factor. The second form factor housing the donor antenna can be placed outside where the wireless signals between the base station and wireless repeater system will likely be stronger.

In aspects, a wireless repeater system can include a repeater, a donor antenna and a reflector. A first form factor can house the repeater, and the second form factor can house the donor antenna. The first and second form factors can be integrally coupled together as a unitary structure, or separated from each other. The reflector can be coupled to the second form factor, be disposed in the second form factor, be integral to the second form factor, or be removably disposed between the first form factor and the second form factor when the second form factor is coupled to the first form factor as a unitary structure. When wireless signals between a base station and the wireless repeater system are above a desired level, the first and second form factors can be place as a unitary structure in a first location inside a house, condominium, apartment, office building, or the like. The reflector can reduce cross coupling between the donor antenna and a server antenna when the first and second form factors are coupled as a unitary structure. However, when the wireless signals between the base station and the wireless repeater system are below a desired level, the first form factor housing the repeater can be placed inside, and the second form factor housing the donor antenna can be placed outside. The first form factor can be placed in a location convenient for plugging the repeater into an electrical outlet, which is also near a door, window or other passage through the walls of the structure that is convenient for routing an RF connection coupling the repeater in the first form factor to the donor antenna in the second form factor. The second form factor housing the donor antenna can be placed outside where the wireless signals between the base station and wireless repeater system will likely be stronger. When the second form factor housing the donor antenna is placed outside, the structure can provide sufficient isolation between the donor antenna and the server antenna, and therefore the reflector can be detached.

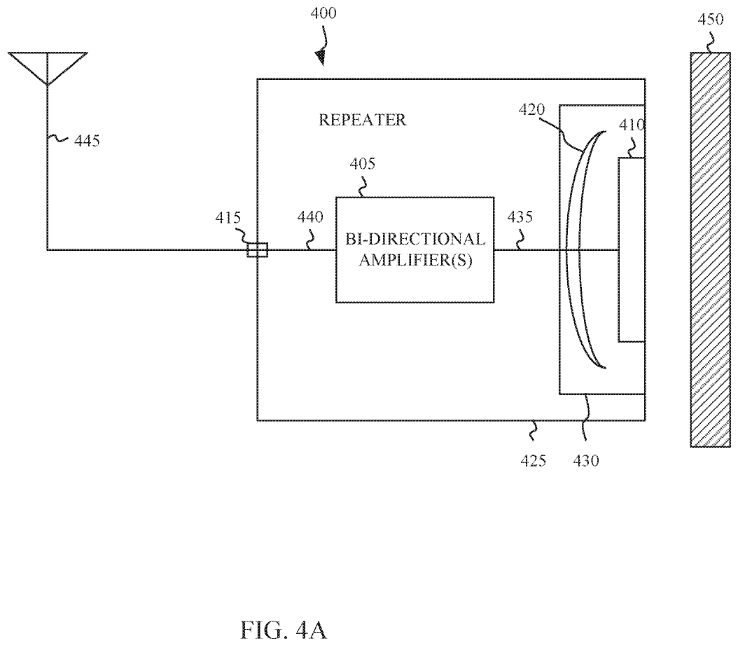

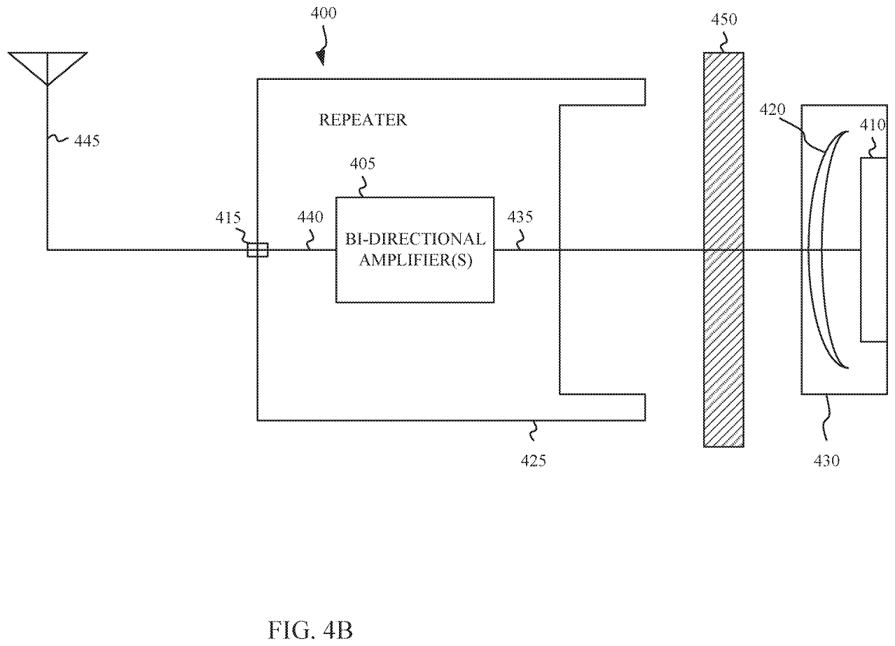

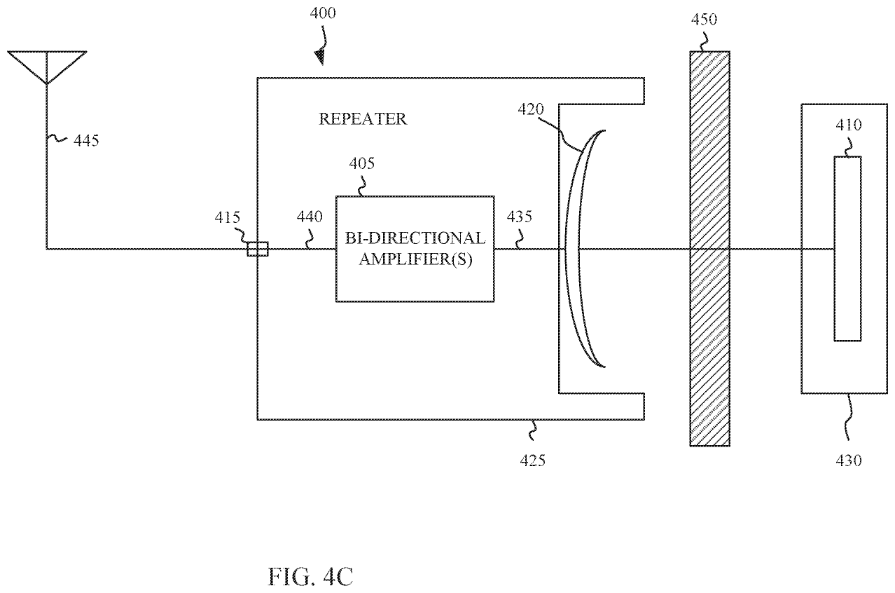

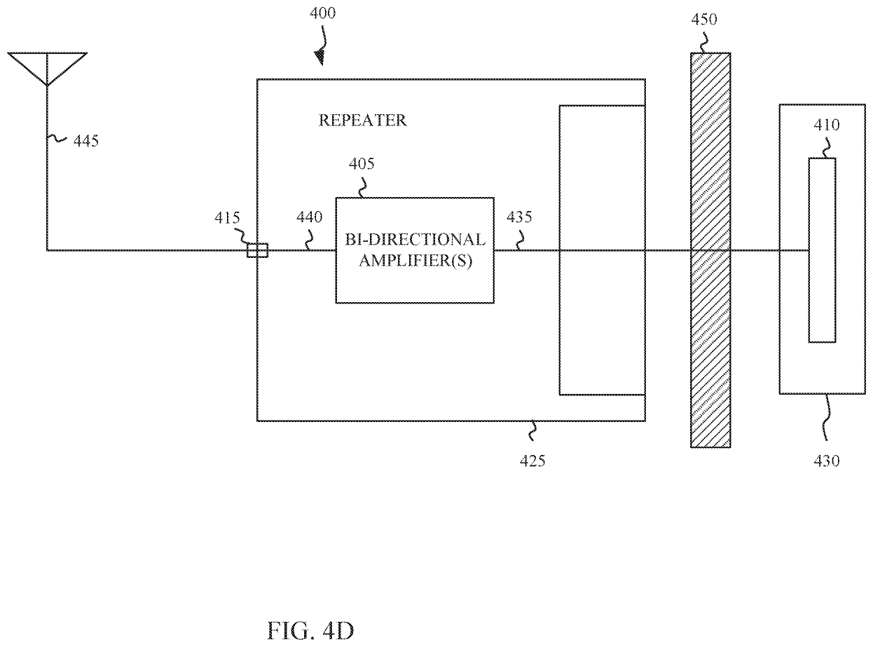

FIGS. 4A-4D depict a wireless repeater system in accordance with an example. In aspects, the repeater 400 can include one or more bi-directional amplifiers 405, a donor antenna 410, a server antenna port 415, or a reflector 420. A first form factor 425 of the repeater 400 can include the server antenna port 415 and the one or more bi-directional amplifiers 405. A second form factor 430 of the repeater 400 can include the donor antenna 410 or the reflector 420. In one implementation, the second form factor can be the donor antenna. In another implementation, the second form factor can house the donor antenna. In another implementation, the second form factor can house the donor antenna and the reflector. In yet another implementation, the second form factor can house the donor antenna and the reflector can be removably attached to the second form factor or the first form factor.

The donor antenna 410 in the second form factor 430 can be coupled to the one or more bi-directional amplifiers 405 in the first form factor 425 by an extendable first radio frequency (RF) conductor 435. The server antenna port 415 can be coupled to the one or more bi-directional amplifiers 405 by a second RF conductor 440. A server antenna 445 can be removably couplable to the server antenna port 415. For example, a coaxial cable can be used to attach or detach the server antenna 445 to the server antenna port 415.

In aspects, the second form factor 430 can be integrally coupled to the first form factor 425, in a first user configurable arrangement, as illustrated in FIG. 4A. In the first user configurable arrangement the first and second form factor 425, 430 integrally coupled together can, for example, be placed in a first location inside a structure 450. In a second user configurable arrangement, the second form factor 430 can be detached from the first form factor 425, while the donor antenna 410 remains electrically coupled to the one or more bi-directional amplifiers 405 by the extendable first RF conductor 435, as illustrated in FIG. 4B. In the second user configurable arrangement, the first form factor 425 can, for example, be placed in the first location inside the structure 450, while the second form factor 430 can be placed outside the structure 450. In both user configurable arrangements, the server antenna 445 can be placed in a second location inside the structure. The first location inside the structure can be, for example, in a convenient location for plugging the repeater 400 into an electrical outlet that is also near a door, window or other passage through the walls of the structure 450. The second location inside the structure can be, for example, in a convenient location that provides a desired RF signal coverage for wireless devices 110 within the structure.

In aspects, the repeater 400 can be configured to amplify one or more RF communication signals. The repeater 400 can, for example, amplify various types of RF signals, such as cellular telephone, WiFi, or AM/FM radio signals. In one instance, the one or more bi-direction amplifier 405 can be configured to amplify both uplink and downlink signals of one or more carrier bands. In one instance, the RF communication signals can be cellular telephone RF signals, such as a Third-Generation Partnership Project (3GPP) Long Term Evolved (LTE) uplink and downlink signals. In one instance, the uplink 3GPP LTE signals may operate at a first frequency band and the downlink 3GPP LTE signal may operate at a second frequency band. In one instance the operating bands of the RF communication signals can include any of the operating bands previously discussed, and the operating bands in Table 4:

TABLE 4
Bands of Operation

| | Uplink | | | | Downlink | | | |
|---|---|---|---|---|---|---|---|---|
| Band | Fmin (MHz) | | Fmax (MHz) | Fc (MHz) | Fmin (MHz) | | Fmax (MHz) | Fc (MHz) |
| II | 1850.0 | - | 1910.0 | 1880.0 | 1930.0 | - | 1990.0 | 1960.0 |
| IV | 1710.0 | - | 1755.0 | 1732.5 | 2110.0 | - | 2155.0 | 2132.5 |
| V | 824.0 | - | 849.0 | 836.5 | 869.0 | - | 894.0 | 881.5 |
| XII | 699.0 | - | 716.0 | 707.5 | 729.0 | - | 746.0 | 737.5 |
| XIII | 776.0 | - | 787.0 | 781.5 | 746.0 | - | 757.0 | 751.5 |

In aspects, the reflector 420 can be utilized to reduce cross coupling between the donor antenna 410 and the server antenna 445. The reflector 420 can also reflect uplink signal transmission from the donor antenna 410 toward the based station 130 to increase uplink signal strength from the donor antenna 410. The reflector 420 can also reflect downlink signal transmission from the base station 130 toward the donor antenna 410 to increase downlink signal reception by the donor antenna 410. In one implementation, the reflector 420 can be coupled to the donor antenna 410 within the second form factor 430, as illustrated in FIG. 4B. In another implementation, the reflector 420 can be coupled to the first form factor 425, as illustrated in FIG. 4C. In other implementations, the reflector 420 can be removably couplable to the first or second form factors 425, 430 as illustrated in FIGS. 4A-4C, or uncoupled from both the first and second form factors as illustrated in FIG. 4D.

In aspects, the examples shown in FIGS. 4A, 4B, 4C and 4D involving the donor antenna 410 can be applicable to the server antenna 445 in a similar manner. For example, the server antenna 445 can be detached or attached to the server antenna port 415. The server antenna 445 can be detachable without the donor antenna 410 being detachable, or vice versa.

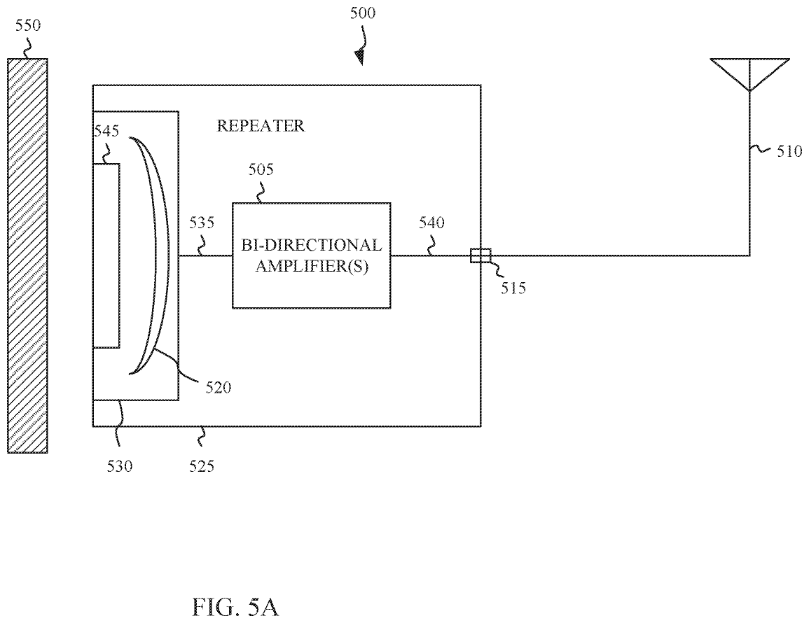

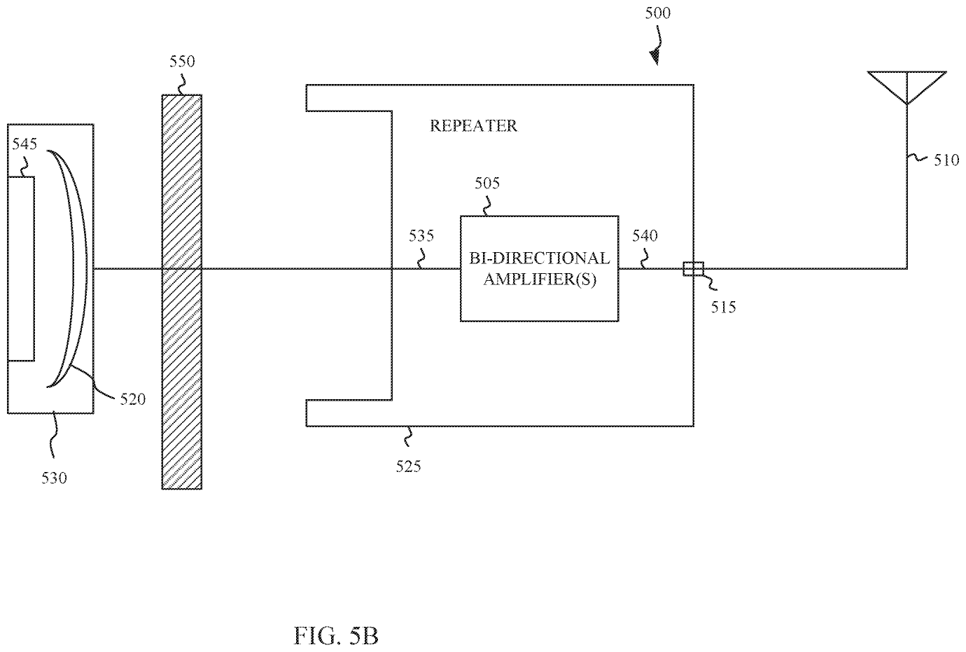

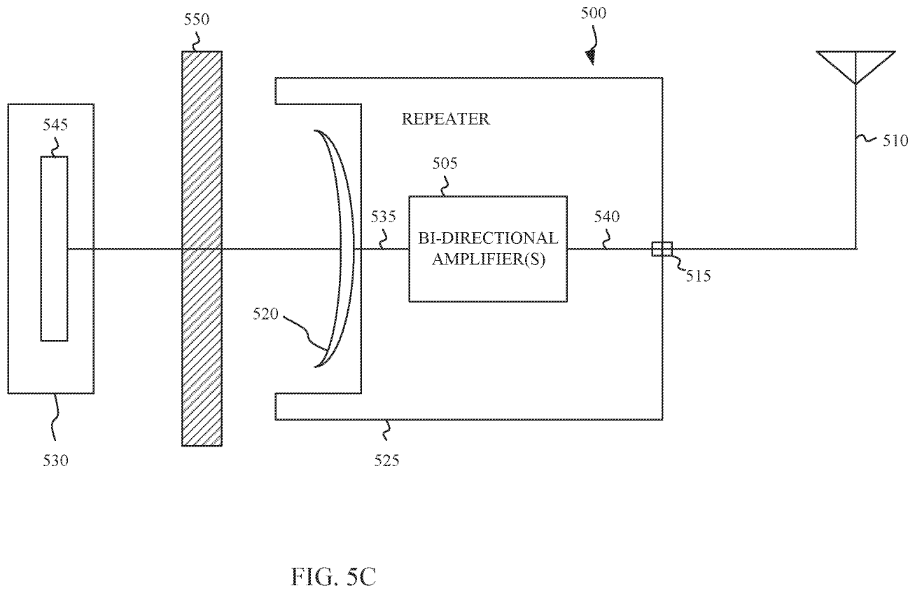

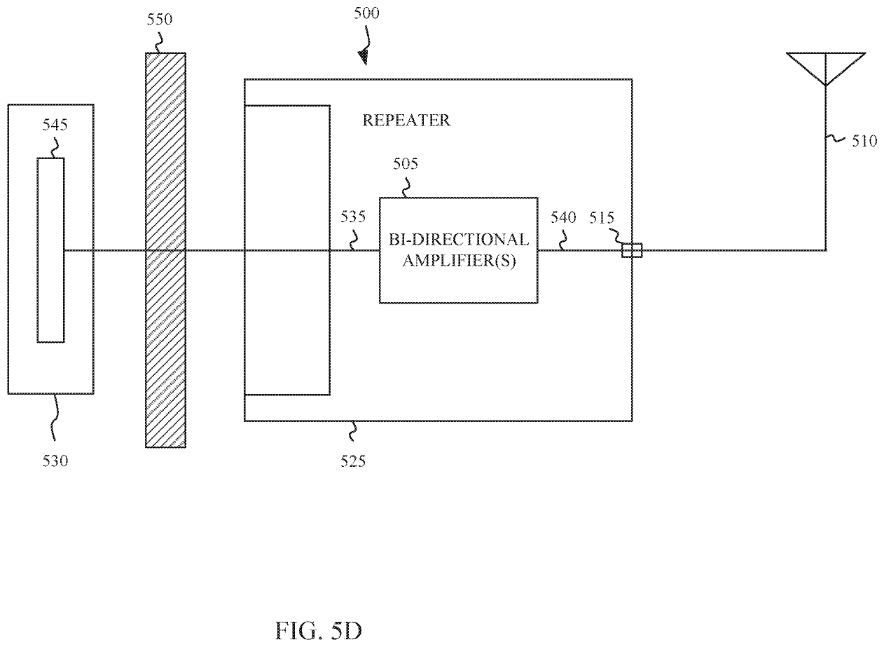

FIGS. 5A-5D depict a wireless repeater system in accordance with an example. In aspects, the repeater 500 can include one or more bi-directional amplifiers 505, a server antenna 545, a donor antenna port 515, or a reflector 520. A first form factor 525 of the repeater 500 can include the donor antenna port 515 and the one or more bi-directional amplifiers 505. A second form factor 530 of the repeater 500 can include the server antenna 545 or the reflector 520. In one implementation, the second form factor 530 can be the server antenna 545. In another implementation, the second form factor 530 can house the server antenna 545. In another implementation, the second form factor 530 can house the server antenna 545 and the reflector 520. In yet another implementation, the second form factor 530 can house the server antenna 545 and the reflector 520 can be removably attached to the second form factor 530 or the first form factor 525.

The server antenna 545 in the second form factor 530 can be coupled to the one or more bi-directional amplifiers 505 in the first form factor 525 by an extendable first radio frequency (RF) conductor 535. The donor antenna port 515 can be coupled to the one or more bi-directional amplifiers 505 by a second RF conductor 540. A donor antenna 510 can be removably couplable to the donor antenna port 515. For example, a coaxial cable can be used to attach or detach the donor antenna 510 to the donor antenna port 515.

In aspects, the second form factor 530 can be integrally coupled to the first form factor 525, in a first user configurable arrangement, as illustrated in FIG. 5A. In the first user configurable arrangement the first and second form factor 525, 530 integrally coupled together can, for example, be placed in a first location outside a structure 550. In a second user configurable arrangement, the second form factor 530 can be detached from the first form factor 525, while the server antenna 545 remains electrically coupled to the one or more bi-directional amplifiers 505 by the extendable first RF conductor 535, as illustrated in FIG. 5B. In the second user configurable arrangement, the first form factor 525 can, for example, be placed in the first location outside the structure 550, while the second form factor 530 can be placed inside the structure 550. In both user configurable arrangements, the donor antenna 510 can be placed in the first location outside the structure 550. The first location outside the structure can be, for example, in a convenient location for plugging the repeater 500 into an electrical outlet that is also near a door, window or other passage through the walls of the structure 550. The second location inside the structure 550 can be, for example, in a convenient location that provides a desired RF signal coverage for wireless devices 110 within the structure 550.

In aspects, the reflector 520 can be utilized to reduce cross coupling between the donor antenna 510 and the server antenna 545. The reflector 520 can also reflect downlink signal transmission from the server antenna 545 toward the wireless devices 110 to increase downlink signal strength from the server antenna 545. The reflector 520 can also reflect uplink signal transmission from the wireless devices 110 toward the server antenna 545 to increase uplink signal reception by the server antenna 545. In one implementation, the reflector 520 can be coupled to the server antenna 545 within the second form factor 530, as illustrated in FIG. 5B. In another implementation, the reflector 520 can be coupled to the first form factor 525, as illustrated in FIG. 5C. In other implementations, the reflector 520 can be removably couplable to the first or second form factors 525, 530 as illustrated in FIGS. 5A-5C, or uncoupled from both the first and second form factors as illustrated in FIG. 5D.

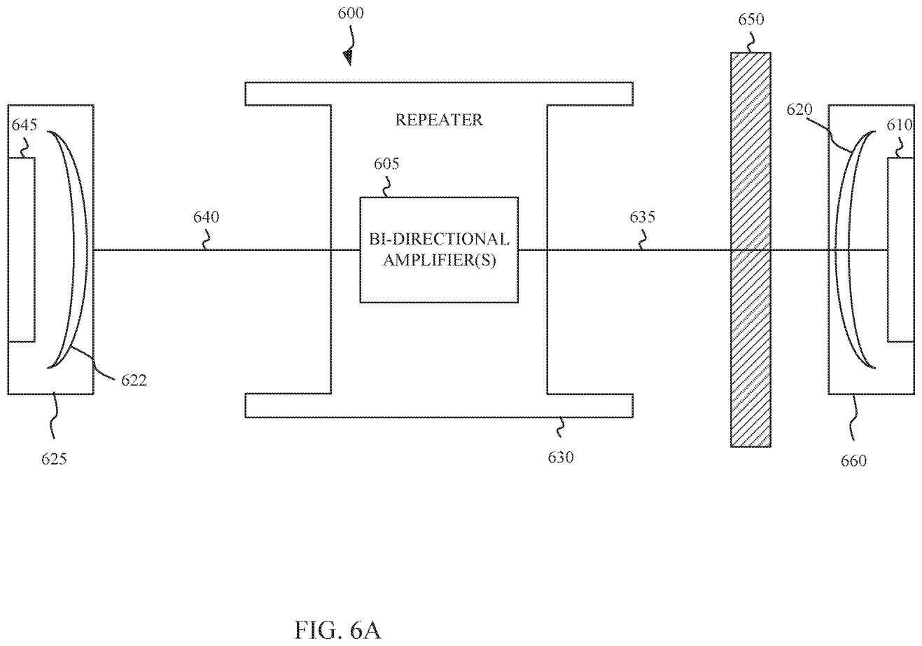

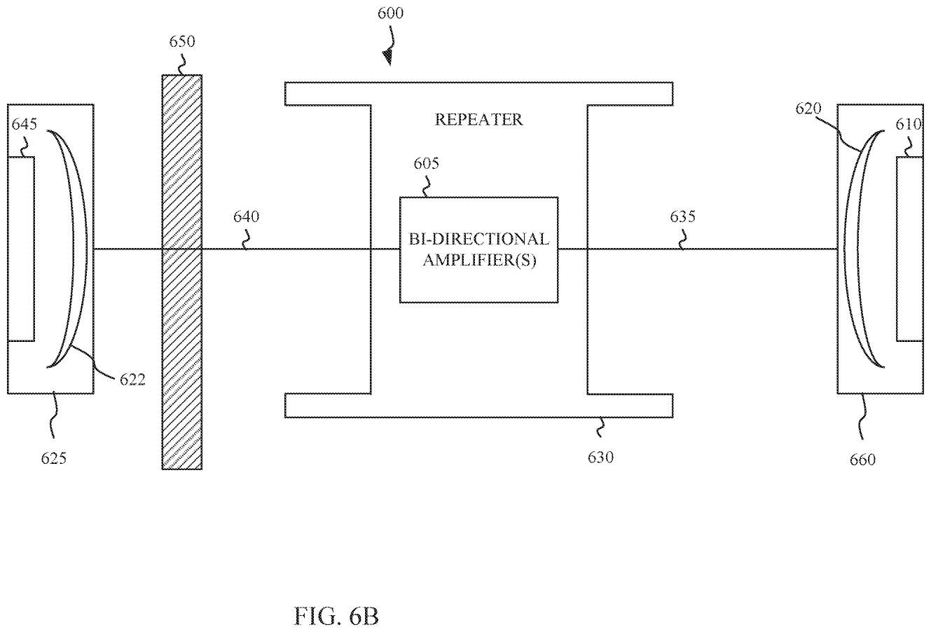

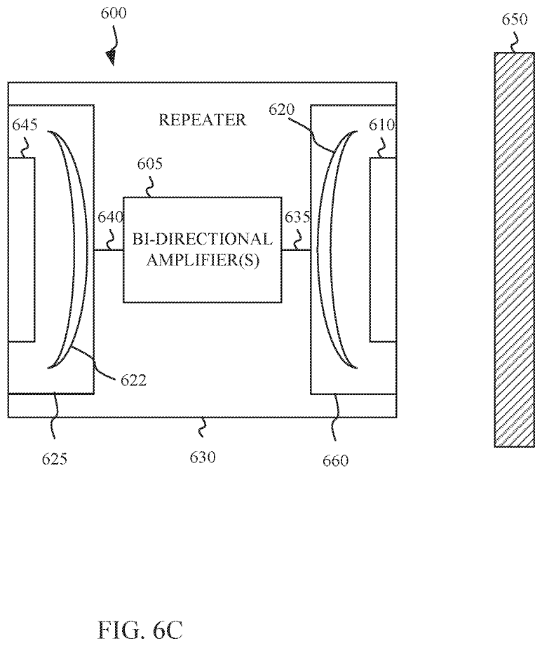

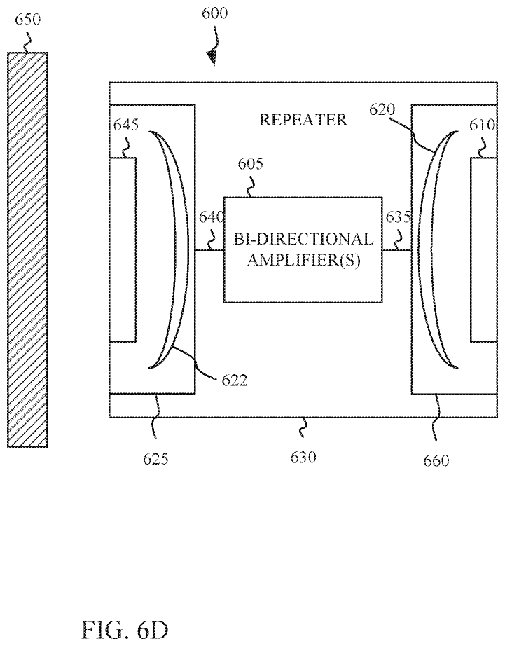

FIGS. 6A-6D depict a wireless repeater system in accordance with an example. In aspects, the repeater 600 can include one or more bi-directional amplifiers 605, a server antenna 645, a donor antenna 610, or reflector(s) 620, 622. A first form factor 625 can include the server antenna 645 or the reflector 622. A second form factor 630 of the repeater 600 can include the one or more bi-directional amplifiers 605. A third form factor 660 can include the donor antenna 610 or the reflector 620.

In aspects, the first form factor 625 and the second form factor 630 can be inside a structure 650, and the third form factor 660 can be outside the structure 650, as illustrated in FIG. 6A. In aspects, the first form factor 625 can be inside a structure 650, and the second form factor 630 and the third form factor 660 can be outside the structure 650, as illustrated in FIG. 6B. In aspects, the first form factor 625 and the third form factor 660 can be attached to the second form factor 630 of the repeater 600, and the repeater 600 can be inside the structure 650, as illustrated in FIG. 6C. In aspects, the first form factor 625 and the third form factor 660 can be attached to the second form factor 630 of the repeater 600, and the repeater 600 can be outside the structure 650, as illustrated in FIG. 6D.

In one implementation, the first form factor 625 can be the server antenna 645. In another implementation, the first form factor 625 can house the server antenna 645. In another implementation, the first form factor 625 can house the server antenna 645 and the reflector 622. In yet another implementation, the first form factor 625 can house the server antenna 645 and the reflector 622 can be removably attached to the second form factor 630 or the first form factor 625.

In one implementation, the third form factor 660 can be the donor antenna 610. In another implementation, the third form factor 660 can house the donor antenna 610. In another implementation, the third form factor 660 can house the donor antenna 610 and the reflector 620. In yet another implementation, the third form factor 660 can house the donor antenna 610 and the reflector 620 can be removably attached to the second form factor 630 or the third form factor 660.

FIG. 7 illustrates a deployment of a wireless repeater system in accordance with an example. In aspects, a first housing 710 of the wireless repeater system can include a repeater, as described above with respect to FIGS. 4A-4D and FIGS. 5A-5D. The first housing 710 can be configurable for placement in a first location inside a structure 720. For example, the first housing 710 can be placed in a living room, conference room or the like.

In aspects, a second housing 730 of the wireless repeater system can include a donor antenna, as described above with respect to FIGS. 4A-4D and FIGS. 5A-5D. The donor antenna in the second housing 730 can be coupled to the repeater in the first housing 710. The second housing 730 can be selectively configurable to be coupled in the first housing in a first configuration. For example, the first and second housings 710, 730 can be coupled as a unitary structure in a first configuration. The second housing may be configured to be coupled within a recess of the first housing, or otherwise coupled to or positioned adjacent to the first housing. In a second configuration the second housing 730 can be configured for placement outside the structure 720. For example, the second housing 730 including the donor antenna can be placed outside a window, door or the like, as illustrated in FIG. 7.

In aspects, the first housing 710 can further include a server antenna port coupled to the repeater, as described above with respect to FIGS. 4A-4D and FIGS. 5A-5D. A server antenna 710 can be removably couplable to the server antenna port. The server antenna 740 can be configurable for placement in a second location inside the structure 720. In another implementation, the first housing 710 can include the server antenna.

In aspects, the first housing 710 can be placed within the structure at a location that is convenient for plugging the repeater into an electrical outlet. The first housing 710 can also be placed within the structure at a location near a door, window or other passage through the walls of the structure 720 that is also convenient for routing an RF connection coupling the repeater in the first housing 710 to the donor antenna in the second housing 730. When the RF signals between a base station and the wireless repeater system are above a desired level, the second housing 730 can be coupled to the first housing 710 as a unitary structure to reduce the footprint of the wireless repeater system inside the structure. However, if the RF signals between the base station and the wireless repeater system are below the desired level, the second housing 730 including the donor antenna can be placed outside the structure to enhance the transmission of the RF signals between the base station and the wireless system. The server antenna 740 can also be placed at a convenient location within the structure 720 that provides a desired RF signal coverage for user equipment devices within the structure.

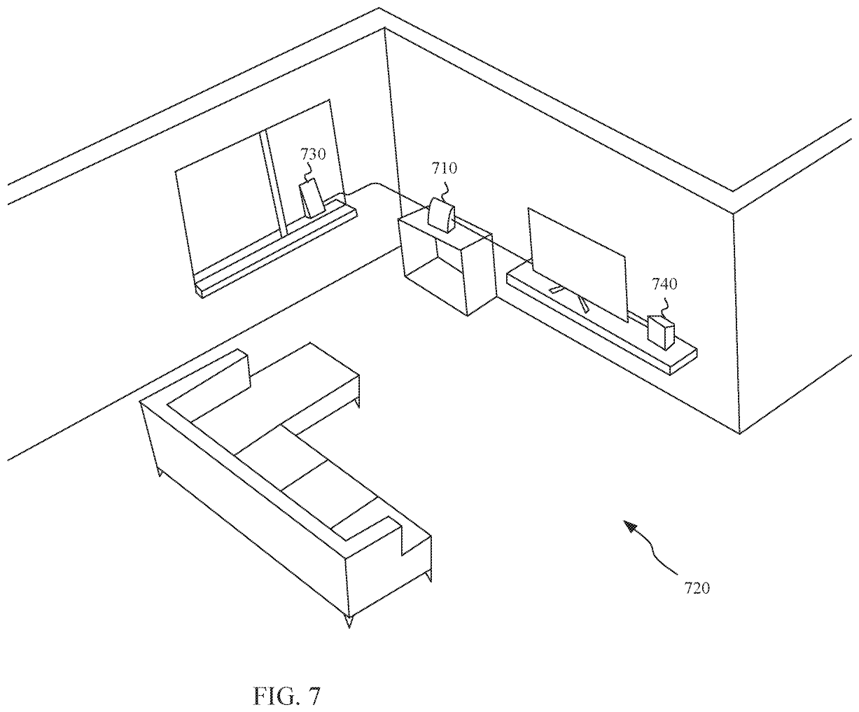

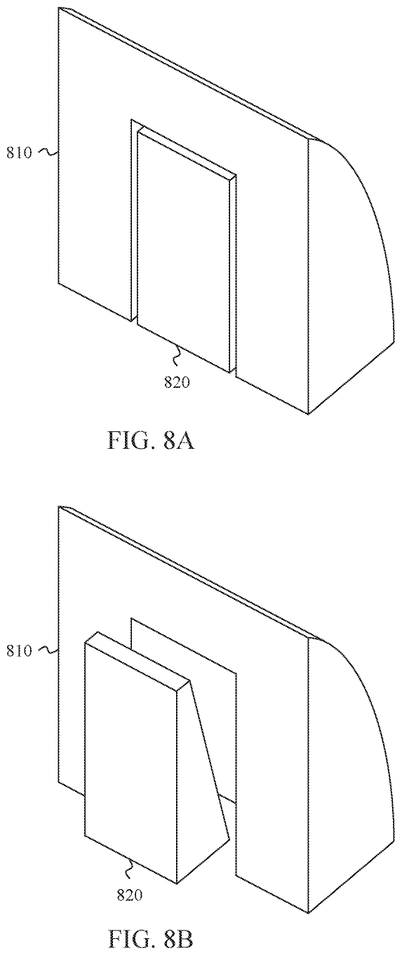

FIGS. 8A-8B depicts a wireless repeater system in accordance with an example. In aspects, the wireless repeater system can include a first enclosure 810 and a second enclosure 820. A repeater can be disposed in the first enclosure 810, and a donor antenna can be disposed in the second enclosure 820, as described above with respect to FIGS. 4A-4D and FIGS. 5A-5D. The second enclosure 820 can be selectively configurable to be coupled with the first enclosure 810 as a unitary structure, as illustrated in FIG. 8A, and as a separate structure from the first enclosure 810, as illustrated in FIG. 8B. As a unitary structure, the second enclosure 820 can be positioned near, located adjacent to, or coupled within a recess in the first enclosure 810. The second enclosure 820 an also be removed and placed separately from the first enclosure 810.

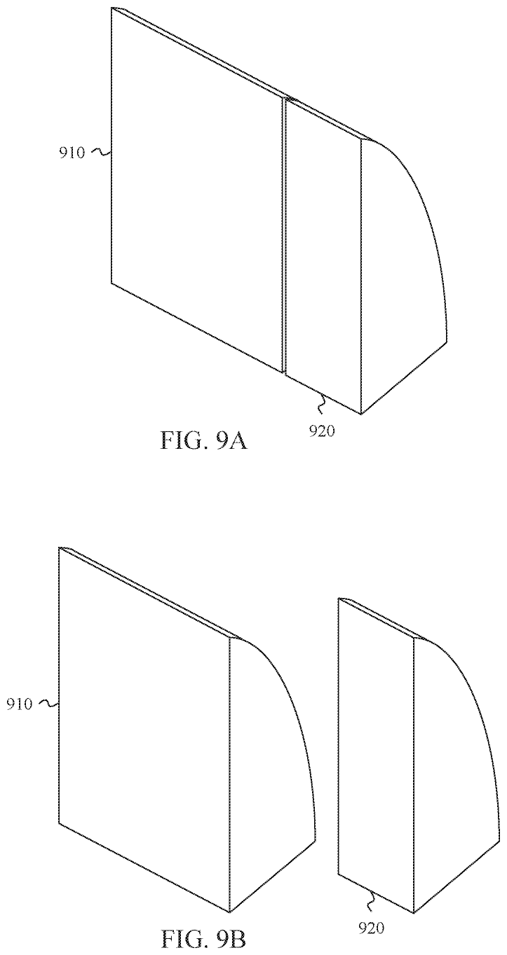

FIGS. 9A-9B depicts a wireless repeater system in accordance with an example. In aspects, the wireless repeater system can include a first enclosure 910 and a second enclosure 920. A repeater can be disposed in the first enclosure 910, and a donor antenna can be disposed in the second enclosure 920, as described above with respect to FIGS. 4A-4D and FIGS. 5A-5D. The second enclosure 920 can be selectively configurable to be coupled with the first enclosure 910 as a unitary structure, as illustrated in FIG. 9A, and as a separate structure from the first enclosure 910, as illustrated in FIG. 9B. As a unitary structure, the second enclosure 920 can be coupled as an extension in the first enclosure 910. The second enclosure 920 an also be removed and placed separately from the first enclosure 910.

In aspects, the wireless repeater system, in accordance with embodiments of the present technology, uses a single donor antenna that can be integrally coupled to the repeater in some configurations, or placed separately from the repeater in other configurations. When the form factor including the donor antenna is integrally coupled to the form factor including the repeater, the overall footprint of the wireless repeater system can be decreased. Alternatively, the form factor including the donor antenna can be separated from the form factor including the repeater and separately placed to enhance transmissions between the repeater and a base station. The use of a single donor antenna that can be configured as a unitary structure with the repeater or as a separate structure eliminates the need for a second donor antenna 230, a donor antenna port 250, and a switch 260. Eliminating the second donor antenna 230, the donor antenna port 240 and switch 260 can reduce the cost of the wireless repeater system. Eliminating the second donor antenna 230, the donor antenna port 240 and switch 260 can reduce the size of the first and/or second form factors. The elimination of the switch 260 can also reduce insertion loss in the repeater cause by the switch.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

### Examples

The following examples pertain to specific technology embodiments and point out specific features, elements, or actions that can be used or otherwise combined in achieving such embodiments.

Example 1 includes a wireless repeater system comprising: one or more bi-directional amplifiers; a donor antenna; a first form factor including the one or more bi-directional amplifiers; and a second form factor including the donor antenna, wherein the second form factor is integrally coupled to the first form factor in a first user configurable arrangement, and the second form factor is separate from the first form factor in a second user configurable arrangement.

Example 2 includes the wireless repeater system of Example 1, wherein the second form factor integrally coupled to the first form factor comprises the second form factor removably coupled with the first form factor.

Example 3 includes the wireless repeater system of any of Examples 1 to 2, wherein the recess in the first form factor is disposed along a back of the first form factor.

Example 4 includes the wireless repeater system of any of Examples 1 to 3, wherein the recess in the first form factor is disposed along a side of the first form factor.

Example 5 includes the wireless repeater system of any of Examples 1 to 4, wherein the second form factor integrally coupled to the first portion for the form factor comprises the second form factor removably coupled as an extension of the first form factor.

Example 6 includes the wireless repeater system of any of Examples 1 to 5, wherein the first form factor and second form factor have substantially similar abutting profiles.

Example 7 includes the wireless repeater system of any of Examples 1 to 6, wherein the second form factor houses the donor antenna.

Example 8 includes the wireless repeater system of any of Examples 1 to 7, wherein the second form factor is the donor antenna.

Example 9 includes the wireless repeater system of any of Examples 1 to 8, further comprising: a reflector coupled to the donor antenna.

Example 10 includes the wireless repeater system of any of Examples 1 to 9, wherein the second form factor houses the reflector and the donor antenna.

Example 11 includes the wireless repeater system of any of Examples 1 to 10, wherein the reflector is integral to the second form factor.

Example 12 includes the wireless repeater system of any of Examples 1 to 11, wherein the reflector is disposed between the first and second form factors when the second form factor is integrally coupled to the first form factor in the first user configurable arrangement.

Example 13 includes the wireless repeater system of any of Examples 1 to 12, further comprising: a server antenna port disposed on the first form factor and electrically coupled to the one or more bi-direction amplifiers.

Example 14 includes the wireless repeater system of any of Examples 1 to 13, further comprising: a server antenna removably coupled to the server antenna port.

Example 15 includes a wireless repeater system comprising: a first enclosure; a repeater disposed in the first enclosure; a second enclosure selectively configurable to be coupled with the first enclosure as a unitary structure and as a separate structure from the first enclosure; and a donor antenna disposed in the second enclosure and electrically coupled to the repeater.

Example 16 includes the wireless repeater system of Example 15, further comprising: a reflector disposed in the second enclosure.

Example 17 includes the wireless repeater system of any of Examples 16 to 16, further comprising: a reflector integral to the second enclosure.

Example 18 includes the wireless repeater system of any of Examples 16 to 17, further comprising: a reflector disposed between the first enclosure and the second enclosure when the second enclosure is coupled to the first enclosure as a unitary structure.

Example 19 includes the wireless repeater system of any of Examples 16 to 18, further comprising: a server antenna port disposed on the first enclosure and electrically coupled to the one or more bi-direction amplifiers.

Example 20 includes the wireless repeater system of any of Examples 16 to 19, further comprising: a server antenna removably coupled to the server antenna port.

Example 21 includes the wireless repeater system of any of Examples 16 to 21, wherein the second enclosure is removably coupled as an extension of the first enclosure when coupled as a unitary structure.

Example 22 includes the wireless repeater system of any of Examples 16 to 22, wherein the first enclosure and second enclosure have substantially similar coupling profiles.

Example 23 includes a wireless repeater system comprising: a first housing including a repeater, the first housing configurable for placement in a first location inside a structure; and a second housing including a donor antenna, wherein the donor antenna is coupled to the repeater, and wherein the second housing is selectively configurable to be coupled integrally to the first housing in a first configuration, and for separate placement outside the structure in a second configuration.

Example 24 includes the wireless repeater system of Example 23, further comprising: the first housing further including a server antenna port coupled to the repeater; and a server antenna removably couplable to the server antenna port and configurable for placement in a second location inside the structure.

Example 25 includes the wireless repeater system of any of Examples 23 to 24, wherein the first housing further includes a server antenna coupled to the repeater.

Example 26 includes the wireless repeater system of any of Examples 23 to 25, wherein the second housing further includes a detachable reflector coupled to the donor antenna and configurable to direct radio frequency emissions from the donor antenna in a predetermined direction.

Example 27 includes the wireless repeater system of any of Examples 23 to 26, wherein the detachable reflector is configurable to be mechanically coupled to the donor antenna when the second housing is coupled integrally to the first housing in the first configuration, and configurable to be detached when the second housing is placed outside the structure in the second configuration.

Example 28 includes the wireless repeater system of any of Examples 23 to 27, further comprising a detachable reflector, wherein the detachable reflector is disposed between the first and second housings when the second housing is coupled integrally to the first housing in the first configuration, and detached from the first and second housings when the second housing is placed outside the structure in the second configuration.

Example 29 includes the wireless repeater system of any of Examples 23 to 28, wherein the second housing is coupled as an extension of the first housing when the second housing is coupled integrally to the first housing in the first configuration.

Example 30 includes the wireless repeater system of any of Examples 23 to 29, wherein the first housing and the second housing have substantially similar abutting profiles when the second housing is coupled integrally to the first housing in the first configuration.

Example 31 includes a wireless repeater system comprising: one or more bi-directional amplifiers; a server antenna; a first form factor including the one or more bi-directional amplifiers; and a second form factor including the server antenna, wherein the second form factor is integrally coupled to the first form factor in a first user configurable arrangement, and the second form factor is separate from the first form factor in a second user configurable arrangement.

Example 32 includes the wireless repeater system Example 31, wherein the recess in the first form factor is disposed along a back of the first form factor.

Example 33 includes the wireless repeater system of any of Examples 31 to 32, wherein the recess in the first form factor is disposed along a side of the first form factor.

Example 34 includes the wireless repeater system of any of Examples 31 to 33, wherein the second form factor integrally coupled to the first portion for the form factor comprises the second form factor removably coupled as an extension of the first form factor.

Example 35 includes the wireless repeater system of any of Examples 31 to 34, wherein the first form factor and second form factor have substantially similar abutting profiles.

Example 36 includes the wireless repeater system of any of Examples 31 to 35, wherein the second form factor houses the server antenna.

Example 37 includes the wireless repeater system of any of Examples 31 to 36, wherein the second form factor is the server antenna.

Example 38 includes the wireless repeater system of any of Examples 31 to 37, further comprising: a reflector coupled to the server antenna.

Example 39 includes the wireless repeater system of any of Examples 31 to 38, wherein the second form factor houses the reflector and the server antenna.

Example 40 includes the wireless repeater system of any of Examples 31 to 39, wherein the reflector is integral to the second form factor.

Example 41 includes the wireless repeater system of any of Examples 31 to 40, wherein the reflector is disposed between the first and second form factors when the second form factor is integrally coupled to the first form factor in the first user configurable arrangement.

Example 42 includes the wireless repeater system of any of Examples 31 to 41, further comprising: a donor antenna port disposed on the first form factor and electrically coupled to the one or more bi-direction amplifiers.

Example 43 includes the wireless repeater system of any of Examples 31 to 42, further comprising: a donor antenna removably coupled to the donor antenna port.

Various techniques, or certain aspects or portions thereof, may take the form of program code (i.e., instructions) embodied in tangible media, such as floppy diskettes, compact disc-read-only memory (CD-ROMs), hard drives, transitory or non-transitory computer readable storage medium, or any other machine-readable storage medium wherein, when the program code is loaded into and executed by a machine, such as a computer, the machine becomes an apparatus for practicing the various techniques. Circuitry may include hardware, firmware, program code, executable code, computer instructions, and/or software. A non-transitory computer readable storage medium may be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). One or more programs that may implement or utilize the various techniques described herein may use an application programming interface (API), reusable controls, and the like. Such programs may be implemented in a high-level procedural or object oriented programming language to communicate with a computer system. However, the program(s) may be implemented in assembly or machine language, if desired. In any case, the language may be a compiled or interpreted language, and combined with hardware implementations.

As used herein, the term processor may include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module cannot be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology may be referred to herein along with alternatives for the various components thereof. It is understood that such embodiments, examples, and alternatives are not to be construed as de facto equivalents of one another, but are to be considered as separate and autonomous representations of the present technology.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology may be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation may be made without the exercise of inventive faculty, and without departing from the principles and concepts of the technology. Accordingly, it is not intended that the technology be limited, except as by the claims set forth below.

What is claimed is:

1. A wireless repeater system comprising:
one or more bi-directional amplifiers;
a first antenna;
a first form factor including the one or more bi-directional amplifiers; and
a second form factor including the first antenna, wherein the second form factor is integrally coupled to the first form factor in a first user configurable arrangement, and the second form factor is separate from the first form factor in a second user configurable arrangement.

2. The wireless repeater system of claim 1, wherein the second form factor integrally coupled to the first form factor comprises the second form factor removably coupled within a recess in the first form factor.

3. The wireless repeater system of claim 2, wherein the recess in the first form factor is disposed along a back of the first form factor.

4. The wireless repeater system of claim 2, wherein the recess in the first form factor is disposed along a side of the first form factor.

5. The wireless repeater system of claim 1, wherein the second form factor integrally coupled to the first portion for the form factor comprises the second form factor removably coupled as an extension of the first form factor.

6. The wireless repeater system of claim 5, wherein the first form factor and second form factor have substantially similar abutting profiles.

7. The wireless repeater system of claim 1, wherein the second form factor houses the first antenna.

8. The wireless repeater system of claim 1, wherein the second form factor is the first antenna.

9. The wireless repeater system of claim 1, further comprising:
a reflector coupled to the first antenna.

10. The wireless repeater system of claim 9, wherein the second form factor houses the reflector and the first antenna.

11. The wireless repeater system of claim 9, wherein the reflector is integral to the second form factor.

12. The wireless repeater system of claim 9, wherein the reflector is disposed between the first and second form factors when the second form factor is integrally coupled to the first form factor in the first user configurable arrangement.

13. The wireless repeater system of claim 1, further comprising:
a second antenna port disposed on the first form factor and electrically coupled to the one or more bi-direction amplifiers.

14. The wireless repeater system of claim 13, further comprising:
a second antenna removably coupled to the second antenna port, wherein the second antenna is a donor antenna or a server antenna.

15. The wireless repeater system of claim 1, wherein the first antenna is a donor antenna or a server antenna.

16. A wireless repeater system comprising:
a first enclosure;
a repeater disposed in the first enclosure;
a second enclosure selectively configurable to be coupled with the first enclosure as a unitary structure and as a separate structure from the first enclosure; and
a donor antenna disposed in the second enclosure and electrically coupled to the repeater.

17. The wireless repeater system of claim 16, further comprising:
a reflector disposed in the second enclosure.

18. The wireless repeater system of claim 16, further comprising:
a reflector integral to the second enclosure.

19. The wireless repeater system of claim 16, further comprising:
a reflector disposed between the first enclosure and the second enclosure when the second enclosure is coupled to the first enclosure as a unitary structure.

20. The wireless repeater system of claim 16, further comprising:
a server antenna port disposed on the first enclosure and electrically coupled to the one or more bi-direction amplifiers.

21. The wireless repeater system of claim 20, further comprising:
a server antenna removably coupled to the server antenna port.

22. The wireless repeater system of claim 16, wherein the second enclosure is removably coupled as an extension of the first enclosure when coupled as a unitary structure.

23. The wireless repeater system of claim 16, wherein the first enclosure and second enclosure have substantially similar coupling profiles.

24. A wireless repeater system comprising:
a first housing including a repeater, the first housing configurable for placement in a first location inside a structure; and
a second housing including a donor antenna, wherein the donor antenna is coupled to the repeater, and wherein the second housing is selectively configurable to be coupled integrally to the first housing in a first configuration, and for separate placement outside the structure in a second configuration.

25. The wireless repeater system of claim 24, further comprising:
the first housing further including a server antenna port coupled to the repeater; and
a server antenna removably couplable to the server antenna port and configurable for placement in a second location inside the structure.

26. The wireless repeater system of claim 24, wherein the first housing further includes a server antenna coupled to the repeater.

27. The wireless repeater system of claim 24, wherein the second housing further includes a detachable reflector coupled to the donor antenna and configurable to direct radio frequency emissions from the donor antenna in a predetermined direction.

28. The wireless repeater system of claim 27, wherein the detachable reflector is configurable to be mechanically coupled to the donor antenna when the second housing is coupled integrally to the first housing in the first configuration, and configurable to be detached when the second housing is placed outside the structure in the second configuration.

29. The wireless repeater system of claim 24, further comprising a detachable reflector, wherein the detachable reflector is disposed between the first and second housings when the second housing is coupled integrally to the first housing in the first configuration, and detached from the first and second housings when the second housing is placed outside the structure in the second configuration.

30. The wireless repeater system of claim 24, wherein:
the second housing is coupled as an extension of the first housing when the second housing is coupled integrally to the first housing in the first configuration; or
the first housing and the second housing have substantially similar abutting profiles when the second housing is coupled integrally to the first housing in the first configuration.
